(19) United States
(12) Patent Application Publication
(10) Pub. No.: US 2016/0240065 A1
(43) Pub. Date: Aug. 18, 2016

(54) FLUID DISRUPTION DETECTION APPARATUS

(71) Applicant: SAMSUNG DISPLAY CO., LTD., Yongin-si (KR)

(72) Inventor: Byong-Ho SHIN, Asan-si (KR)

(21) Appl. No.: 14/862,179

(22) Filed: Sep. 23, 2015

(30) Foreign Application Priority Data
Feb. 13, 2015 (KR) 10-2015-0022412

(51) Int. Cl. G08B 21/18; G01V 1/00; G01V 8/20

(52) U.S. Cl. CPC G08B 21/18; G01V 8/20; G01V 1/001

(57) ABSTRACT

A fluid disruption detection apparatus includes a frame surrounding a passage through which fluid is to penetrate and a fluid disruption detector coupled with the body member to detect fluid disruption.

### CROSS-REFERENCE TO RELATED APPLICATION

Korean Patent Application No. 10-2015-0022412, filed on Feb. 13, 2015, in the Korean Intellectual Property Office, and entitled: “Fluid Cracking Detection Apparatus,” is incorporated by reference herein in its entirety.

### BACKGROUND

1. Field

Embodiments relate to a fluid disruption detection apparatus.

2. Description of the Related Art

Supplying a fluid flow to a surface of a substrate (e.g., glass) as a fluid curtain (e.g., shower) during, e.g., a cleaning or etching process in manufacturing, e.g., a liquid crystal display (LCD) or an organic light emitting diode display (OLED), may be frequently used. The fluid supplying may be performed by discharging a fluid onto a substrate moving in one direction through an injection nozzle. The fluid may be applied to the substrate in a curtain shape.

When foreign matters are caught in a gap of the nozzle through which the fluid curtain is injected, the fluid curtain may be disrupted, e.g., cracked. In this case, a fluid contact liquid is non-uniformly applied to the surface of the substrate and, thus, defects may occur.

The above information disclosed in this Background section is only for enhancement of understanding of the background of the disclosure and, therefore, may contain information that does not form the prior art that is already known in this country to a person of ordinary skill in the art.

### SUMMARY

One or more embodiments are directed to a fluid disruption detection apparatus including a frame surrounding a passage through which a fluid is to penetrate and a fluid disruption detector coupled with the frame to detect fluid disruption.

The frame may include a first support part and a second support part spaced apart from each other in accordance with the fluid to pass therethrough, and two connection parts connecting adjacent ends of the first support part and the second support part. The fluid disruption detector may include a plurality of first sensors at any one of the first support part and the second support part to generate a detection signal.

The first sensor may be an ultrasonic wave transducer.

The fluid disruption detector may include a plurality of second sensors on the frame, the plurality of second sensors being opposite the plurality of first sensors across the passage.

The first sensor may be an emitter to emit the detection signal and the second sensor is a detector to detect the detection signal.

The first sensor may be an infrared light emitting diode (LED) and the second sensor is an infrared detector.

The plurality of first sensors and the plurality of second sensors may be in one-to-one correspondence.

The frame may be a rectangle.

The fluid disruption detection apparatus may include an alarm in communication with the fluid disruption detector to emit an alarm signal when the fluid disruption detector detects fluid disruption.

The alarm may be on the frame.

The alarm signal may be light.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of a fluid disruption detection apparatus according to an exemplary embodiment.

FIG. 2 illustrates a plan view of a fluid disruption detection apparatus according to another exemplary embodiment.

FIG. 3 illustrates a diagram of detecting fluid disruption using the fluid disruption detection apparatus shown in FIG. 2.

FIG. 4 illustrates a cross-sectional view taken along the line II-II in the fluid disruption detection apparatus shown in FIG. 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Accordingly, the drawings and description are to be regarded as illustrative in nature and not restrictive. Like reference numerals designate like elements throughout the specification.

In addition, in several exemplary embodiments, components having the same configuration will be representatively described using the same reference numerals in an exemplary embodiment, and only components different from those of an exemplary embodiment will be described in the other exemplary embodiments.

Throughout this specification and the claims that follow, when it is described that an element is “coupled” to another element, the element may be “directly coupled” to another element through the other member. In addition, unless explicitly described to the contrary, the word “comprise” and variations such as “comprises” or “comprising”, will be understood to imply the inclusion of stated elements but not the exclusion of any other elements.

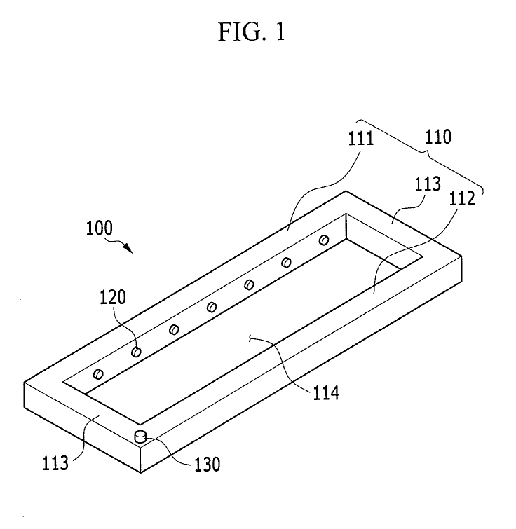

FIG. 1 illustrates a perspective view of a fluid disruption apparatus according to an exemplary embodiment. Referring to FIG. 1, a fluid disruption apparatus 100 according to an exemplary embodiment includes a frame 110 and a fluid disruption detector 120.

The frame 110 surrounds a passage 114 through which a fluid is to pass. A shape of the frame 110 may be, for example, a rectangle, but is not limited thereto, i.e., as long as the frame 110 surrounding the passage 114 accommodates the fluid to flow therethrough, the frame 110 may be any shape.

For example, the frame 110 may include quadrangular pipes are connected to form a rectangle. As described above, the frame 110 has a simple structure and thus may be easily manufactured at a size corresponding to a fluid injection device which makes a fluid flow in a substrate.

The fluid disruption detector 120 may be coupled with, e.g., mounted on, integrated with, and so forth, the frame 110. The fluid disruption detector 120 detects fluid disruption. For this purpose, a detailed structure of the fluid disruption detector 120 and the frame 110 will be described.

The frame 110 may include a first support part 111, a second support part 112, and two connection parts 113. The first support part 111 and the second support part 112 may have, for example, a bar shape. The two connection parts 113 connect adjacent ends of the first support part 111 and the second support part 112. The first support part 111 and the second support part 112 are spaced apart from each other sufficiently to accommodate the fluid to flow therethrough, while being long enough to accommodate the fluid to flow therethrough.

The fluid disruption detector 120 may include a plurality of first sensors 120. The plurality of first sensors 120 may be adjacent, e.g., mounted on, any one of the first support part 111 and the second support part 112 to generate detection signals toward the other one thereof. The plurality of first sensors 120 may be positioned at a predetermined interval, e.g., may be evenly spaced. The first sensors 120 may be, for example, an ultrasonic wave transducers, e.g., ultrasonic waves are output by the first sensors 120 adjacent one support part to the opposite support part across the passage 114, which are then reflected back by the fluid passing therethrough and/or the other support part to be detected by the first sensors 120, such that changes in the detected waves may indicate disruption in the fluid flow.

The fluid disruption detection apparatus 100 according to the exemplary embodiment may further include an alarm 130. The alarm 130 may be on the frame 110 and may be in communication with, e.g., electrically connected to the fluid disruption detector 120. The alarm 130 may emit an alarm signal, e.g., sound, light, and so forth, when the fluid disruption detector 120 detects fluid disruption. A worker may confirm the fluid disruption using the alarm signal emitted from the alarm 130.

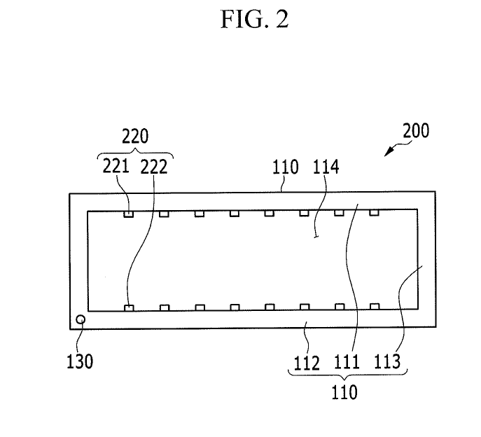

FIG. 2 illustrates a plan view of a fluid disruption detecting apparatus according to another exemplary embodiment. Referring to FIG. 2, a fluid disruption detection apparatus 200 according to another exemplary embodiment includes a fluid disruption detector 220 having a plurality of first sensors 221 and a plurality of second sensors 222.

The second sensors 222 on one of the first and second supports parts 111 and 112 on which the first sensors 221 are not and are positioned to face the first sensors 221, i.e., the first and second sensors 221 and 222 may be opposite one another across the passage 114. For example, when the first sensors 221 are on the first support part 111, the second sensors 222 are on the second support part 112, and vice versa. For convenience of explanation, only the case in which the first sensors 221 are on the first support part 111 and the second sensors 222 are on the second support part 112 will be described with reference to the drawings.

As such, the first sensors 221 may be, e.g., an infrared light emitting diode (LED) and the second sensors 222 may be, e.g., an infrared detection sensor. Infrared rays irradiated from the infrared light emitting diode (LED) may be detected by the infrared detector. Other complementary emitter/detector pairs may be employed as suitable.

The plurality of first sensors 221 and the plurality of second sensors 222 may be in one-to-one correspondence. For example, when ten first sensors 221 are on the first support part 111, ten second sensors 222 are on the second support part 112. These first and second sensors may be aligned to be directly opposite each other across the passage 114.

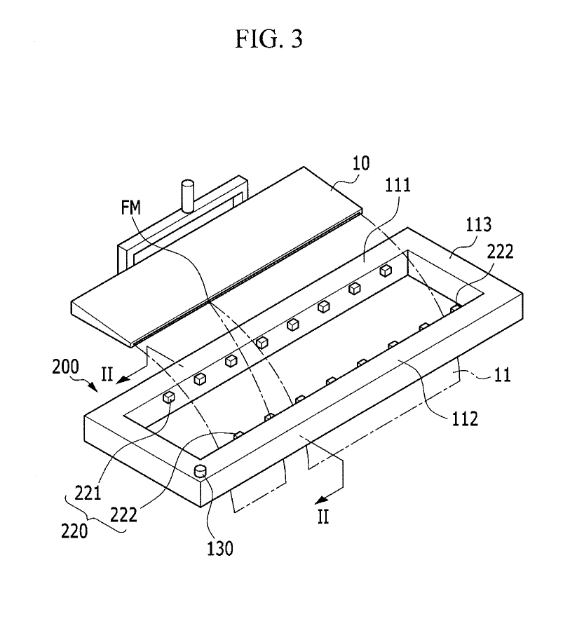

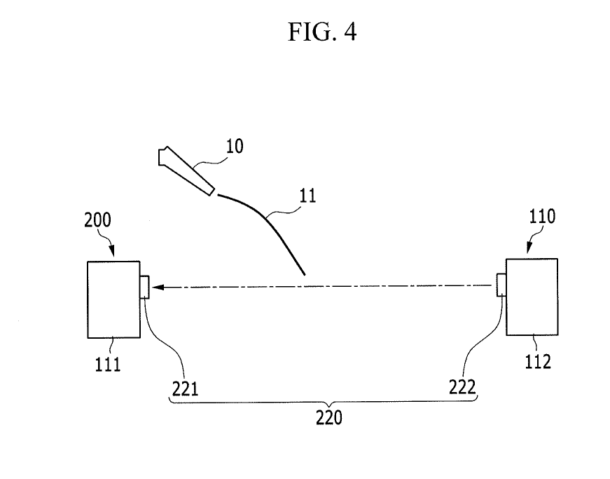

FIG. 3 illustrates a diagram of detecting the fluid disruption using the fluid disruption detection apparatus as shown in FIG. 2. FIG. 4 is a cross-sectional view taken along the line II-II in the fluid disruption detection apparatus shown in FIG. 3.

As illustrated in FIGS. 3 and 4, a detection signal is continuously generated by the first sensors 221 of the fluid disruption detector 220. In this state, when the fluid 11 is normally discharged in a curtain shape from the nozzle 10, the detection signal is refracted by the fluid 11. Therefore, the second sensors 222 do not receive the detection signal, e.g., infrared light, and the fluid disruption detector 220 determines that the fluid 11 is normally discharged in the curtain shape.

However, when foreign matters FM are caught in the nozzle 10, such that disruption occurs in the curtain-shaped fluid 11, the detection signal is not refracted. Therefore, as the second sensors 222 receive the detection signal, the fluid disruption detector 220 determines that disruption occurs in the fluid 11.

By way of summation and review, one or more embodiments may provide a fluid disruption detection apparatus capable of automatically and rapidly identifying fluid disruption. In contrast to relying on workers to frequently confirm whether the fluid curtain disruption occurs, quality of objects to be manufactured may be improved, as well as worker productivity. Further, workers need not confirm fluid disruption in real time, thereby reducing the labor costs.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A fluid disruption detection apparatus, comprising:
a frame surrounding a passage through which a fluid is to penetrate; and
a fluid disruption detector coupled with the frame to detect fluid disruption.

2. The fluid disruption detection apparatus as claimed in claim 1, wherein:
the frame includes;
a first support part and a second support part spaced apart from each other in accordance with the fluid to pass therethrough, and
two connection parts connecting adjacent ends of the first support part and the second support part; and
the fluid disruption detector includes a plurality of first sensors at any one of the first support part and the second support part to generate a detection signal.

3. The fluid disruption detection apparatus as claimed in claim 2, wherein the first sensor is an ultrasonic wave sensor.

4. The fluid disruption detection apparatus as claimed in claim 2, wherein the fluid disruption detector includes a plurality of second sensors on the frame, the plurality of second sensors being opposite the plurality of first sensors across the passage.

5. The fluid disruption detection apparatus as claimed in claim 4, wherein:
the first sensor is an emitter to emit the detection signal; and
the second sensor is a detector to detect the detection signal.

6. The fluid disruption detection apparatus as claimed in claim 5, wherein:
the first sensor is an infrared light emitting diode (LED); and
the second sensor is an infrared detector.

7. The fluid disruption detection apparatus as claimed in claim 4, wherein the plurality of first sensors and the plurality of second sensors are in one-to-one correspondence.

8. The fluid disruption detection apparatus as claimed in claim 1, wherein the frame is a rectangle.

9. The fluid disruption detection apparatus as claimed in claim 1, further comprising an alarm in communication with the fluid disruption detector, the alarm to emit an alarm signal when the fluid disruption detector detects the fluid disruption.

10. The fluid disruption detection apparatus as claimed in claim 9, wherein the alarm signal is light.

11. The fluid disruption detection apparatus as claimed in claim 9, wherein the alarm is on the frame.
